(19) United States
(12) Patent Application Publication
(10) Pub. No.: US 2024/0428964 A1
(43) Pub. Date: Dec. 26, 2024

(54) POWER CABLE WITH REDUCED SHRINK BACK

(71) Applicant: NKT HV Cables AB, Lyckeby (SE)

(72) Inventor: Tommy Johansson, Bräkne-Hoby (SE)

(21) Appl. No.: 18/702,832

(22) PCT Filed: Nov. 1, 2022
(86) PCT No.: PCT/EP2022/080456

§ 371 Date: Apr. 19, 2024

(30) Foreign Application Priority Data
Nov. 1, 2021 (SE) 2151341-1

(51) Int. Cl. H01B 9/02; H01B 7/02

(52) U.S. Cl. CPC H01B 9/027; H01B 7/02

(57) ABSTRACT

A power cable including: a conductor, an insulation system including: an inner semiconducting layer arranged radially outside the conductor, an insulation layer arranged radially outside the inner semiconducting layer, and an outer semiconducting layer arranged radially outside the insulation layer, and an adhesive layer arranged between the conductor and the inner semiconducting layer, the adhesive layer directly contacting an inner surface of the inner semiconducting layer and/or the adhesive layer directly contacting an outer surface of the conductor.

### TECHNICAL FIELD

The present disclosure generally relates to power cables such as submarine power cables and land power cables.

### BACKGROUND

Power cables typically comprise a conductor covered by an insulation system. The insulation moves axially relative to the conductor due to thermal shrinkage, especially close to the cable ends or at a rigid joint close to the conductor joint. As a result, a portion of the conductor may thus become exposed, i.e., without insulation. The length of exposed conductor is called shrink back. The shrink back reaches a steady state after a number of heat cycles.

Shrink back is dependent on the insulation thickness, conductor material, type, and size, and the insulation extrusion procedure.

There are several ways to reduce shrink back. For example, the connection sleeve of a rigid joint and the end portion of the insulation system adjacent to the connection sleeve may be provided with a respective circumferential groove interlocked by means of an anchoring element as disclosed by EP1158638 B1. Nevertheless, it would be desirable to provide alternative means for reducing shrink back or axial movement of the insulation system relative to the conductor in general.

### SUMMARY

There is provided a power cable comprising: a conductor, an insulation system comprising: an inner semiconducting layer arranged radially outside the conductor, an insulation layer arranged radially outside the inner semiconducting layer, and an outer semiconducting layer arranged radially outside the insulation layer, and an adhesive layer arranged between the conductor and the inner semiconducting layer, the adhesive layer directly contacting an inner surface of the inner semiconducting layer and/or the adhesive layer directly contacting an outer surface of the conductor.

The adhesive layer restricts axial movement of the inner semiconducting layer relative to the conductor. Shrink back can thus be eliminated or at least reduced.

The power cable may be a DC cable or an AC cable comprising one or more power cores.

The power cable may be a low voltage, a medium voltage, or a high voltage power cable.

The power cable may be a land power cable or a submarine power cable.

The insulation system may be an extruded insulation system, or a mass impregnated insulation system made of layers of tapes.

According to one embodiment the adhesive layer adheres the inner semiconducting layer to the conductor.

According to one embodiment the conductor has an outer surface that has one or more portions that are free of the adhesive layer.

According to one embodiment the adhesive layer is electrically insulating, and wherein the inner semiconducting layer is arranged in electrical contact with the conductor.

According to one embodiment the adhesive layer is semiconductive and the adhesive layer covers the entire or essentially the entire outer surface of the conductor.

One embodiment comprises a tape layer arranged between the conductor and the inner semiconducting layer, wherein the adhesive layer is arranged between the tape layer and the inner semiconducting layer, the adhesive layer being provided on an outer surface of the tape layer adhering the tape layer to the inner semiconducting layer.

According to one embodiment the tape layer comprises an adhesive that adheres to the conductor.

One embodiment comprises a tape layer arranged between the conductor and the inner semiconducting layer, wherein the adhesive layer is arranged between the tape layer and the conductor, the adhesive layer being provided on an inner surface of the tape layer adhering the tape layer to the conductor.

According to one embodiment the tape layer is semiconducting.

According to one embodiment the adhesive layer is formed of a glue, a hot-melt adhesive, or an adhesive plastic.

The adhesive layer may comprise a maleic-anhydride-(MAH)-functionalised polyolefin, such as MAH-functionalised polyethylene (PE).

Generally, all terms used in the claims are to be interpreted according to their ordinary meaning in the technical field, unless explicitly defined otherwise herein. All references to a/an/the element, apparatus, component, means, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 is a cross-sectional view of an example of a power cable;

FIG. 2 is a cross-sectional view of another example of a power cable; and

FIG. 3 is a cross-sectional view of another example of a power cable.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

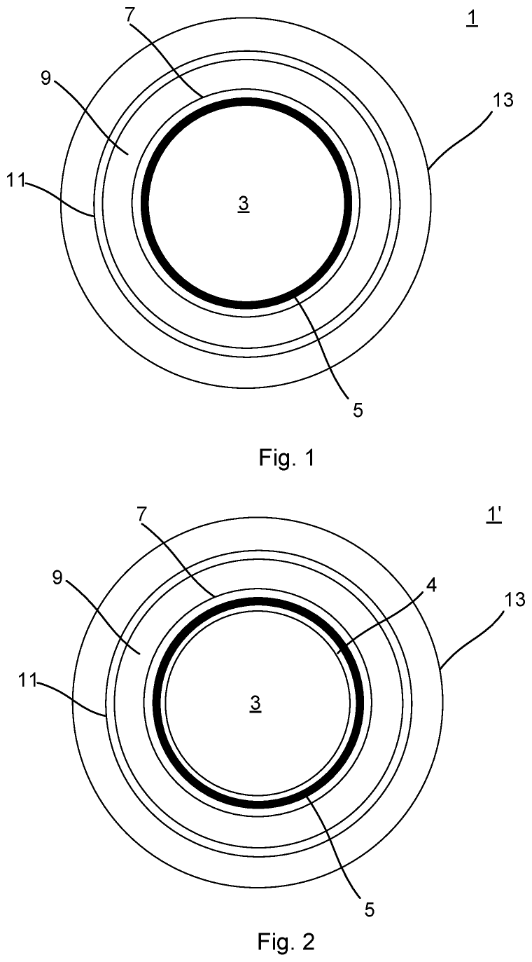

FIG. 1 schematically shows a cross-sectional view of an example of a power cable 1.

The power cable 1 is in this example a single power core power cable. Alternatively, the power cable could comprise several identical power cores to form a multi-core power cable, such as three-phase power cable.

The power cable 1 comprises a conductor 3. The conductor 3 may for example be stranded, segmental of Milliken type, solid, or a profile wire conductor.

The conductor 3 may for example comprise copper or aluminium.

The power cable 1 comprises an insulation system covering the conductor 3.

The insulation system comprises an inner semiconducting layer 7 arranged around the conductor 3. The inner semiconducting layer 7 forms a conductor screen.

The insulation system comprises an insulation layer 9 arranged around the inner semiconducting layer 7.

The insulation system comprises an outer semiconducting layer 11 arranged around the insulation layer 9. The outer semiconducting layer 11 forms an insulation screen.

The insulation system may be extruded and comprise a thermosetting or thermoplastic polymer material, or it may be made of oil impregnated paper tapes. In case of extrusion, the polymeric material may for example be cross-linked polyethylene (XLPE), polypropylene (PP), EPDM rubber, or EPR rubber.

The exemplified power cable 1 comprises an adhesive layer 5. The adhesive layer 5 is arranged between the outer surface of the conductor 3 and the inner surface of the inner semiconducting layer 11. The adhesive layer 5 makes the inner semiconducting layer 7 adhere to the conductor 3. To this end, the adhesive layer 5 may be in direct contact with the conductor 3 and with the inner semiconducting layer 7.

The adhesive layer 5 is formed of a glue, a hot-melt adhesive, or an adhesive plastic.

The adhesive layer 5 may be electrically insulating. In this case, the adhesive layer 5 does not cover the entire outer surface of the conductor 3. There are some portions or regions distributed in the circumferential and the axial direction of the conductor 3 that are free of adhesive so that electrical contact between the conductor 3 and the inner semiconducting layer 7 can be made in these portions or regions by direct contact between the conductor 3 and the inner semiconducting layer 7.

The adhesive layer 5 may alternatively be semiconducting. In this case, the adhesive layer 5 may cover the entire outer surface of the conductor 3.

The power cable 1 comprises an outer sheath or outer serving 13 arranged around the outer semiconducting layer 11. The outer sheath or serving 13 may comprise a polymeric material that is extruded around the insulation system or it may comprise polymeric yarn laid around the longitudinal axis of the power cable 1.

In examples comprising several power cores, each power core comprises a conductor, an insulation system and the adhesive layer between the inner semiconducting layer and the conductor. The power cores may be stranded and surrounded by an outer sheath or outer serving.

It is to be noted that there may optionally be other layers present in the power cable 1 not shown in FIG. 1, such as a screen layer, one or more bedding layers, a water barrier layer made of lead or other metal, e.g., copper, a copper alloy, aluminium, or stainless steel, one or more armour wire layers, a bitumen layer, etc.

The adhesive layer may according to some examples be provided on the conductor by means of spraying or by extrusion.

FIG. 2 shows another example of a power cable. The power cable 1′ depicted in FIG. 2 is similar to the power cable 1 described above with reference to FIG. 1. A difference between the power cable 1 and the power cable 1′ is that the power cable 1′ additionally comprises a tape layer 4. The tape layer 4 is arranged between the conductor 3 and the inner semiconducting layer 7. The tape layer 4 adheres to the outer surface of the conductor 3. The adhesive layer 5 is provided between the tape layer 4 and the inner semiconducting layer 7 and contacts the outer surface of the taper layer 4 and the inner surface of the inner semiconducting layer 7 directly. The adhesive layer 5 thus makes the tape layer 4 adhere to the inner surface of the inner semiconducting layer 7.

The adhesive layer 5 may form the outer surface of the tape layer 4.

The tape forming the tape layer 4 may for example be wound around the conductor 3 during the process of manufacturing the conductor, prior to providing the insulation system around the conductor 3. The adhesive layer 5, which may form the outer surface of the tape layer 4, may in this case be melted during e.g., extrusion of the insulation system by the heat developed during the extrusion process.

The tape may according to one example have an adhesive layer on both its inner and outer surface, or on its inner surface only, as shown in FIG.

3, which depicts a power cable 1″ comprising the adhesive layer 5 provided only on the inner surface of the tape layer 4. The adhesive layer 5 is arranged directly between the conductor 3 and the tape layer 4. The adhesive layer 5 thus adheres the tape layer 4 to the conductor 3.

The friction is lower between the tape layer 4 and the conductor 3 than between the tape layer 4 and the inner semiconducting layer 7. By providing the adhesive layer 5 between the tape layer 4 and the conductor 3 sliding of the tape layer 4 relative to the conductor 3 is restricted.

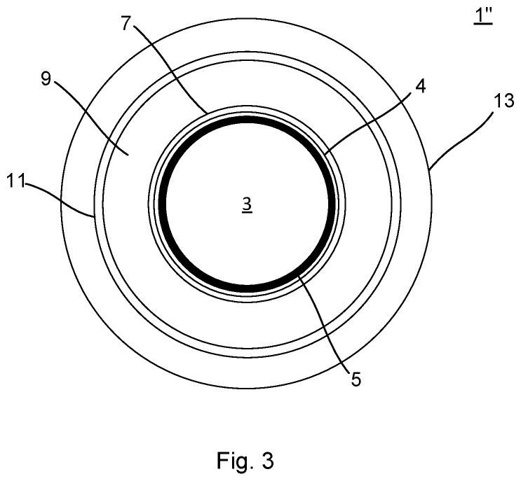

The tape layer 4 may in the examples in FIG. 2 and FIG. 3 for example comprise water-swellable tape or a conductor tape.

The adhesive layer 5 may in the examples in FIGS. 2 and 3 be semiconducting, in which case the entire tape layer 4 or conductor 3 may be covered by the adhesive layer 5. The tape layer 4 may be semiconducting. Alternatively, the adhesive layer 5 may be electrically insulating and cover only a portion or portions of the tape layer 4 or conductor 3. Electrical contact may then be achieved between the conductor 3 and the inner semiconducting layer 7, especially if the tape layer 4 is semiconducting.

The inventive concept has mainly been described above with reference to a few examples. However, as is readily appreciated by a person skilled in the art, other embodiments than the ones disclosed above are equally possible within the scope of the inventive concept, as defined by the appended claims.

1. A power cable comprising:
a conductor,
an insulation system comprising having:
an inner semiconducting layer arranged radially outside the conductor,
an insulation layer arranged radially outside the inner semiconducting layer, and
an outer semiconducting layer arranged radially outside the insulation layer; and
an adhesive layer arranged between the conductor and the inner semiconducting layer, the adhesive layer directly contacting an inner surface of the inner semiconducting layer and/or the adhesive layer directly contacting an outer surface of the conductor.

2. The power cable as claimed in claim 1, wherein the conductor has an outer surface that has one or more portions that are free of the adhesive layer.

3. The power cable as claimed in claim 2, wherein the adhesive layer is electrically insulating, and wherein the inner semiconducting layer is arranged in electrical contact with the conductor.

4. The power cable as claimed in claim 1, wherein the adhesive layer is semiconductive and the adhesive layer covers the entire or essentially the entire outer surface of the conductor.

5. The power cable as claimed in any of the preceding claim 1, comprising a tape layer arranged between the conductor and the inner semiconducting layer, wherein the adhesive layer is arranged between the tape layer and the inner semiconducting layer, the adhesive layer being provided on an outer surface of the tape layer adhering the tape layer to the inner semiconducting layer.

6. The power cable as claimed in claim 1, comprising a tape layer arranged between the conductor and the inner semiconducting layer, wherein the adhesive layer is arranged between the tape layer and the conductor, the adhesive layer being provided on an inner surface of the tape layer adhering the tape layer to the conductor.

7. The power cable as claimed in claim 5, wherein the tape layer is semiconducting.

8. The power cable as claimed in any of the claim 1, wherein the adhesive layer is formed of a glue, a hot-melt adhesive, or an adhesive plastic.

9. The power cable as claimed in claim 2, comprising a tape layer arranged between the conductor and the inner semiconducting layer, wherein the adhesive layer is arranged between the tape layer and the inner semiconducting layer, the adhesive layer being provided on an outer surface of the tape layer adhering the tape layer to the inner semiconducting layer.

10. The power cable as claimed in claim 2, comprising a tape layer arranged between the conductor and the inner semiconducting layer, wherein the adhesive layer is arranged between the tape layer and the conductor, the adhesive layer being provided on an inner surface of the tape layer adhering the tape layer to the conductor.

11. The power cable as claimed in claim 2, wherein the adhesive layer is formed of a glue, a hot-melt adhesive, or an adhesive plastic.

12. The power cable as claimed in claim 3, comprising a tape layer arranged between the conductor and the inner semiconducting layer, wherein the adhesive layer is arranged between the tape layer and the inner semiconducting layer, the adhesive layer being provided on an outer surface of the tape layer adhering the tape layer to the inner semiconducting layer.

13. The power cable as claimed in claim 3, comprising a tape layer arranged between the conductor and the inner semiconducting layer, wherein the adhesive layer is arranged between the tape layer and the conductor, the adhesive layer being provided on an inner surface of the tape layer adhering the tape layer to the conductor.

14. The power cable as claimed in claim 3, wherein the adhesive layer is formed of a glue, a hot-melt adhesive, or an adhesive plastic.

15. The power cable as claimed in claim 4, comprising a tape layer arranged between the conductor and the inner semiconducting layer, wherein the adhesive layer is arranged between the tape layer and the inner semiconducting layer, the adhesive layer being provided on an outer surface of the tape layer adhering the tape layer to the inner semiconducting layer.

16. The power cable as claimed in claim 4, comprising a tape layer arranged between the conductor and the inner semiconducting layer, wherein the adhesive layer is arranged between the tape layer and the conductor, the adhesive layer being provided on an inner surface of the tape layer adhering the tape layer to the conductor.

17. The power cable as claimed in claim 4, wherein the adhesive layer is formed of a glue, a hot-melt adhesive, or an adhesive plastic.

18. The power cable as claimed in claim 6, wherein the tape layer is semiconducting.
